(19) United States
(12) Patent Application Publication
(10) Pub. No.: US 2006/0220349 A1
(43) Pub. Date: Oct. 5, 2006

(54) High chair

(75) Inventors: Melissa A. Wolf, Coatesville, PA (US); Dennis R. Stauffer, Birdsboro, PA (US); Paul Nelson, Elverson, PA (US); Herman J. Shie, Pottstown, PA (US); Matthew J. Ransil, Richland, PA (US); William B. Bellows, Wyomissing, PA (US); Thomas M. Perrin, Thorndale, PA (US)

Correspondence Address: LEMPIA IP GROUP, LLC, 223 WEST JACKSON BLVD., SUITE 1100, BROOKS BLDG., CHICAGO, IL, 60606, US

(73) Assignee: Graco Children's Products Inc., Exton, PA (US)

(21) Appl. No.: 11/374,375

(22) Filed: Mar. 13, 2006

Related U.S. Application Data
(60) Provisional application No. 60/661,487, filed on Mar. 15, 2005.

(51) Int. Cl. B62B 9/00

(52) U.S. Cl. 280/650

(57) ABSTRACT

A compact folding high chair has a foldable frame assembly with a front frame section and a rear frame section pivotally coupled to one another at their respective upper ends. The frame assembly is movable to a folded configuration where the front and rear frame sections are spaced a close distance relative to one another. A front and a rear toe surface are provided on the respective lower ends of the front and rear frame sections. The front and rear toe surfaces are spaced a stabilizing distance from one another in the folded configuration. The stabilizing distance is greater than the close distance of the frame sections. The folded high chair can stand upright on the toe surfaces and remain relatively stable even though the frame sections are close to one another when folded.

### RELATED APPLICATION DATA

This patent is related to and claims priority benefit of U.S. provisional patent application Ser. No. 60/661,487, which was filed on Mar. 15, 2005.

### BACKGROUND OF THE INVENTION

1. Field of the Disclosure

The present invention is generally directed to high chairs, and more particularly to a high chair that folds compactly and has feet that create a stable base to stand and retain the folded high chair in an upright orientation.

2. Description of Related Art

High chairs and foldable high chairs are known in the art. High chairs are also known that fold to a compact size with a shallow depth or narrow profile when viewed from the side. However, these types of high chairs typically are not capable of readily or easily standing upright when in the folded configuration. This is because the bottom ends of the front and rear high chair legs or frame sections are positioned very close together when in the folded configuration. The gap between front and rear contact points of this type of folded high chair is small, resulting in a shallow base for standing the folded high chair upright.

Some high chairs have rollers, wheels, or casters on the bottom ends of their legs or frame sections. When this type of high chair is in the folded configuration and stood upright, the high chair rests on the wheels or casters, which still bear against the floor surface. This results in very little surface contact between the bottom of the high chair legs and the ground or support surface. If all of the wheels are not locked to prevent rotation, the wheels can then rotate or spin, further reducing the stability of the high chair when folded and standing upright.

Either or both of the above factors result in a thin-profile folded high chair either being easily tipped over or completely incapable of standing upright when folded.

### BRIEF DESCRIPTION OF THE DRAWINGS

Objects, features, and advantages of the present invention will become apparent upon reading the following description in conjunction with the drawing figures, in which:

FIG. 1 is a front perspective view of one example of a high chair constructed in accordance with the teachings of the present invention.

FIG. 2 is a side view of the high chair shown in FIG. 1 and in an in-use or unfolded configuration.

FIG. 3 is a side view of the high chair shown in FIG. 1 and in a folded configuration standing upright.

FIG. 4 is a cross-section of one example of a high chair foot assembly taken along line IV-IV of FIG. 1 and showing the wheel brake components in a released orientation.

FIG. 5 is a cross-section of the high chair foot assembly of FIG. 4, but showing the wheel brake components in a locked orientation.

### DETAILED DESCRIPTION OF THE DISCLOSURE

The high chair disclosed herein is one example of a thin-profile or compact foldable high chair. The disclosed high chair, when moved to a folded configuration, can stand upright and yet remain stable and relatively sturdy. The high chair example disclosed herein has front and rear legs, each with a lower end that terminates in at least one foot assembly. In one example, the foot assemblies have a bottom surface with a toe end and a heel end. A toe surface is positioned at a free or distal end of each foot assembly and is oriented at an angle relative to the bottom surface. When the high chair in this example is in the in-use configuration, the front and rear legs are spread wide apart from one another and the bottom surfaces face the ground or floor surface. The high chair will rest either directly on the bottom surfaces or, if utilized, on wheels exposed through the bottom surfaces of the foot assemblies.

When the disclosed high chair is in a folded configuration, the lower ends of the front legs are positioned closely spaced from the lower ends of the rear legs on each side of the high chair. In this example, the toe surfaces contact the ground or floor when the high chair is stood upright. The toe surfaces of the one or more front foot assemblies are offset forward relative to the position of the lower ends of the front legs. Similarly, the toe surfaces of the one or more rear foot assemblies are offset rearward relative to the position of the lower ends of the rear legs. Thus, the toe surfaces create a wider gap or greater depth distance between the front and rear folded legs of the high chair in this example. This construction results in a more stable base for supporting the folded, narrow, or thin profile high chair in an upright or standing orientation in comparison to previously known thin profile, foldable high chairs.

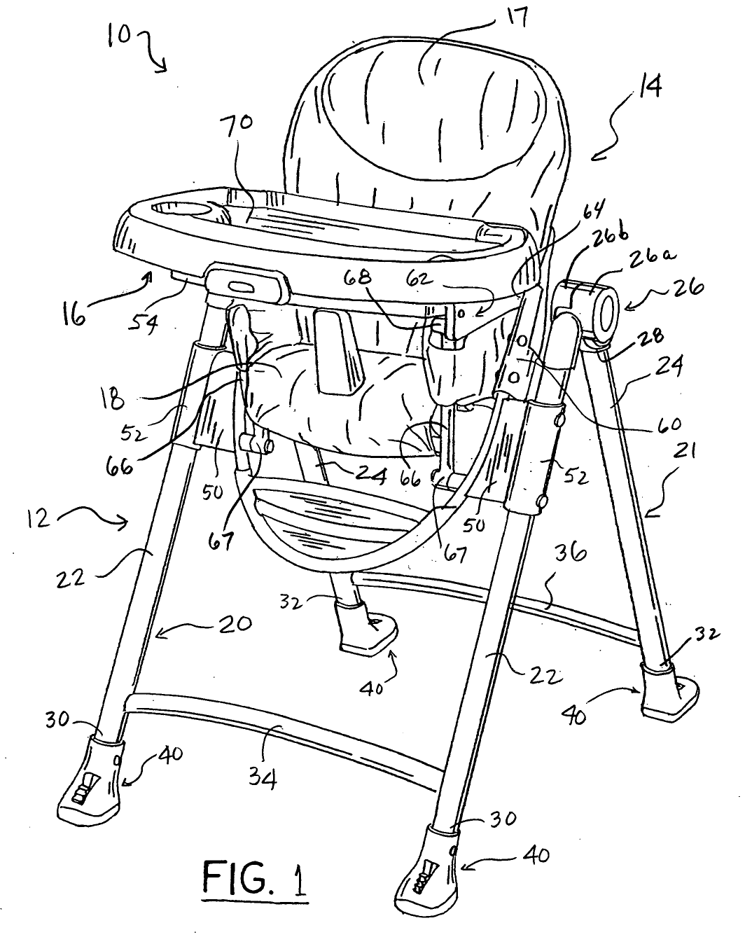

Turning now to the drawings, FIG. 1 is a perspective front view of one example of a high chair 10 constructed in accordance with the teachings of the present invention. The high chair 10 in the disclosed example has a frame assembly 12 that supports a seat 14 in an elevated position above the ground or a floor on which the high chair rests. In this example, the frame assembly 12 has an A-frame configuration when viewed from the side. The high chair 10 also has a tray 16 in the disclosed example that is positioned spaced forward of a seat back 17 and above a seat bottom 18 of the seat.

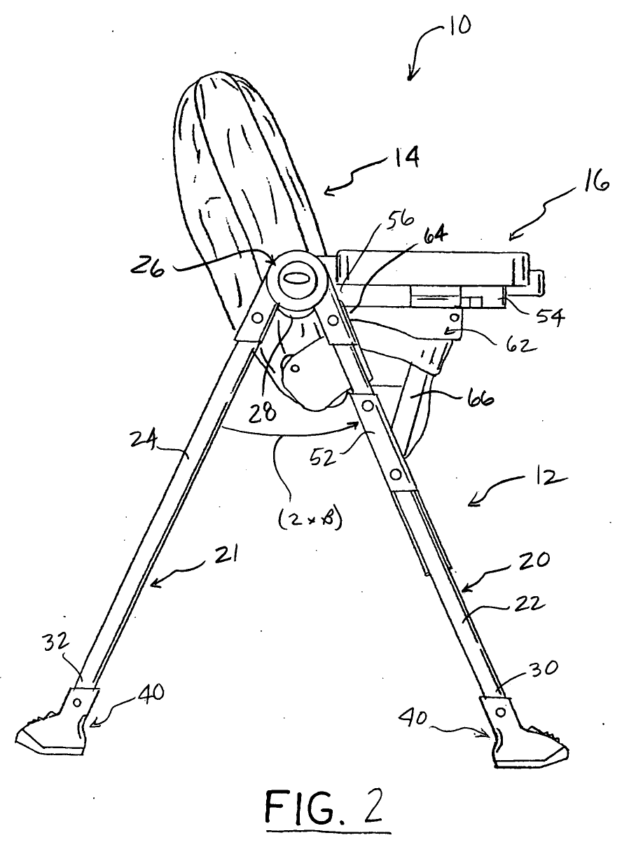

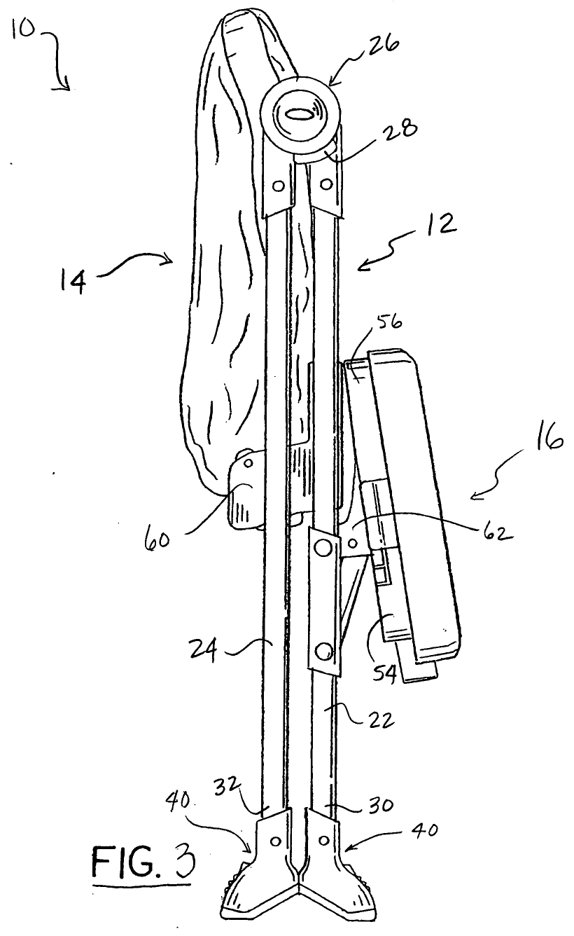

In this example, the A-frame assembly 12 incorporates a front frame section 20 and a rear frame section 21. The front and rear sections 20 and 21 are pivotally foldable relative to one another between an in-use configuration as shown in FIG. 2 and a compactly folded configuration as shown in FIG. 3. The front frame section 20 has a pair of front legs 22 laterally spaced apart from one another across the width of the A-frame structure 12. Similarly, the rear frame section 21 has a pair of rear legs 24 laterally spaced apart from one another across the width of the A-frame assembly 12. In this example, each of the legs 22 and 24 is essentially a linear or straight element. The front legs 22 are substantially parallel to one another when viewed from the front and the rear legs are substantially parallel to one another when viewed from the rear. The front frame section 20 and front legs 22 are called “front” components herein for convenience of description, as they are positioned forward of the seat 14 relative to the seat facing direction. The rear frame section 21 and rear legs 24 are described herein as “rear” components also for ease of description, as they are positioned behind the seat 14.

Each side of the frame assembly 12 in this example also has a hub 26 connected to an upper end of one of the front legs 22 and one of the rear legs 24. Each hub 26 in this example has two parts 26a and 26b pivotally coupled together. One of the front legs 22 is connected to one part 26a of each hub and one of the rear legs 24 is connected to the other part 26b of each hub. The front legs 22 and rear legs 24 can pivot toward and away from one another at each hub 26 between the in-use and folded configurations. The hubs 26 each have a lock release button 28 facing downward in this example. The lock release button 28 can be depressed upward in this example to permit relative rotation between the hub components 26a and 26b of each hub as is known in the art between the in-use and the folded configurations of FIGS. 2 and 3.

Each front leg 22 also terminates at a discrete lower end 30 and each rear leg 24 terminates at a discrete lower end 32 in this example. A front cross-brace 34 rigidly interconnects and extends between the spaced apart front legs 22 at a position spaced upward from the lower ends 30. Similarly, a rear cross-brace 36 rigidly interconnects and extends between the rear legs 24 at a position spaced upward from their respective lower ends 32. In accordance with the teachings of the present invention, a foot assembly 40 is attached to or carried on the lower end 30 and 32 of each of the legs 22 and 24. The characteristics and flnctions of the foot assemblies are described in greater detail below.

Those having ordinary skill in the art will readily recognize that the various structural details of the high chair can vary considerably and yet fall within the spirit and scope of the present invention. The structure, function, and configuration of the frame assembly 12, seat 14, the tray 16, if present, can all vary considerably from the examples disclosed herein and perform their intended function. Particularly, the frame assembly 12 can vary from that shown. For example, the frame structure can utilize U-shaped front and rear frame sections, inverted T-shaped front and rear frame sections, or the like. Additionally, the frame assembly 12 need not incorporate linear or straight legs, but instead can use curved or contoured legs as desired. Further, the legs 22 and 24 of the frame assembly 12 need not be parallel to one another either when viewed from wither the front or the back, when viewed from the side when in the folded configuration, or both. Also, the frame assembly 12 can have essentially a single lower front end and rear end, pairs of lower front legs and rear legs as described herein, or an even greater number of front and rear floor contact points.

In this example, a pair of seat brackets 50 is positioned one on each side of the seat 14 and extending laterally outward from the seat. Each of the brackets 50 is connected at its proximal end to the seat 14 and has a tube connector 52 on its distal end. Each tube connector 52 in this example is slidably and telescopically received over an exterior of a correspondingly positioned one of the front legs 22. The seat 14 is positioned between the spaced apart front legs 22 and spaced apart rear legs 24 and supported on the front legs 22 by the brackets 50. The seat 14 can be slid up or down along the front legs 22 as desired to adjust the seat height or to lower the seat in the folded configuration to minimize the overall size of the folded high chair 10. Any suitable mechanisms can be employed to lock or release the seat 14, and particularly the tube connectors 52, at a desired position along the front legs 22.

The tray 16 in this example is removable from and attachable to a sub-tray 54. The sub-tray 54 is supported by a slidable and pivotable linkage arrangement on the high chair and can be secured in an in-use position as shown in FIGS. 1 and 2 or moved to a dropped-down position as shown in FIG. 3 when the high chair 10 is folded. A tray support bracket 60 is provided on each side of the seat. A rear end 56 of each side of the sub-tray 54 is pivotally coupled to a respective one of the tray brackets 60. A slide track 62 is provided on each side of the sub-tray 54 and is pivotally coupled at a rear end 64 to the tray bracket 60 on each side of the tray. A tray brace 66 is positioned on each side of the tray 16 and each has a lower end 67 pivotally coupled to one of the seat brackets 50. An upper end 68 of each tray brace 66 is coupled to its corresponding slide track 62 so that it can slide, roll, or otherwise move along the track. In the in-use position, the upper ends 68 of the tray braces 66 are slid forward along the tracks 62 until they each pop or snap into the in-use position as shown in FIG. 1. Conventional release buttons (not shown) can be provided on each side of the tray 16 to release the tray braces 66 from the in-use position so that they are free to slide along the tracks 62 toward the rear ends 64 of the tracks. As the tray braces slide rearward along the tracks 66, the sub-tray 58 drops down to the folded position as shown in FIG. 3.

As noted above, the configuration and construction of the seat and tray components can vary considerably and yet fall within the spirit and scope of the present invention. The manner in which the seat is mounted to the high chair frame can vary from that disclosed. The linkage of the tray that moves the tray between the in-use and folded configurations can change. The sub-tray can be eliminated. A tray insert 70 can be provided and loosely fitted to the tray 16 if desired.

Turning now to FIGS. 1, 4, and 5, one of the foot assemblies 40 is now described in greater detail. In the disclosed example, the high chair 10 has four feet assemblies 40, one on the lower end 30 or 32 of each leg 22 and 24. Each foot assembly 40 in the disclosed example has a foot body 82 with a proximal or heel end and a toe or distal end. A hosel or ankle 84 is positioned on the proximal or heel end and is connected to the lower end 30 or 32 of its corresponding leg 22 or 24. The manner in which each foot 40 is connected to its respective leg can also vary considerably and yet fall within the spirit and scope of the present invention, depending upon the size, shape, and construction of the lower end of each frame section 20 and 21. In this example, each hosel 84 is a hollow tube sized to fit the lower end 30 or 32 of a corresponding one of the legs of the frame assembly 12. Each hosel 84 is slipped over an end of a leg and secured by a pair of opposed fasteners 85 to the leg.

In the disclosed example, the body 82 of each foot assembly 40 has a hollow interior 86, a bottom surface 88, and a toe or contact surface 90. An optional wheel 92 is shown to project through an opening 93 in the bottom surface 88 of each foot assembly. In this example, the wheels 92 and not the bottom surfaces 88 contact the ground or the floor when the high chair is in the in-use configuration as shown in FIGS. 1 and 2. In another example, the wheels 92 can be eliminated and the feet can be configured to rest directly on their bottom surfaces when in the in-use configuration. In the disclosed example, each wheel 92 is rotatably carried on an axle or pivot 94. The wheels 92 are free to rotate when the high chair 10 is moved along a surface on which the wheels rest.

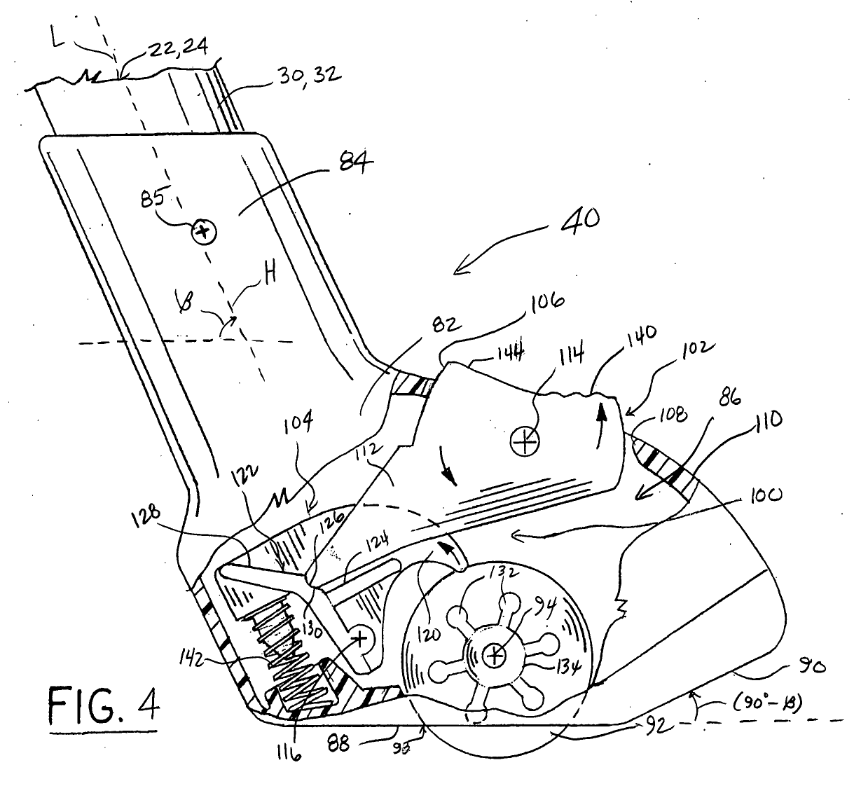

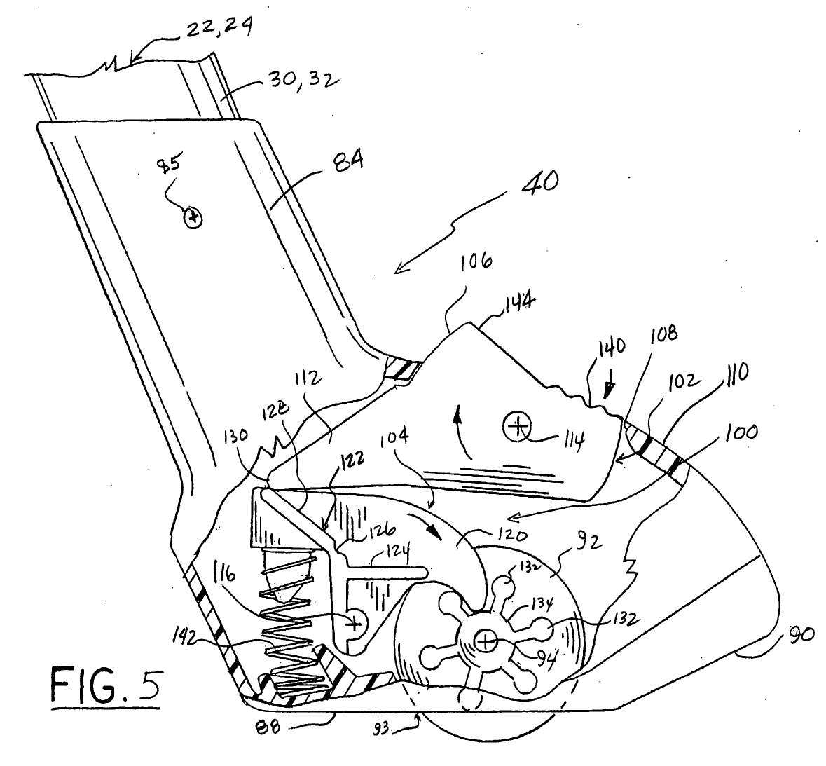

Each foot assembly 40 in this example also has a brake assembly 100, which can be manipulated to either permit free rotation of the wheel 92 or prevent rotation as is known in the art. Each brake assembly 100 in the disclosed example includes an actuator 102 and a brake lever 104 that interact with one another to lock or release the wheel 92. In the disclosed example, the brake actuator 102 has a toggle button 106 exposed through an opening 108 in a top 110 of the foot body 82. The button 106 is integrally connected to an actuator lever 112 that extends toward and contacts a portion of the brake lever 104. The brake actuator 102 is supported on a pivot 114 positioned between the button 106 and the lever 112 and can rotate between a released position as shown in FIG. 4 and a locked position as shown in FIG. 5.

The brake lever 104 is also supported for rotation on a separate brake pivot 116. The brake lever 104 has a finger 120 that curves and projects radially away from the brake pivot 116. The brake lever 104 also has a multi-faceted surface 122 that has a width in an axial direction relative to the brake pivot 116 and a height in a radial direction away from the brake pivot. The contour of the multi-faceted surface 122 changes over its height. In this example, the multi-faceted surface 122 has a stop section 124 near the brake pivot 116, a detent region 126, and a bearing surface 128 furthest from the brake pivot. The actuator 102 is positioned so that a distal end or tip 130 of the actuator lever can contact the various parts of the surface 122. The stop surface 124 limits travel of the actuator lever 112 of the brake actuator in a direction toward the brake pivot. The detent region 126 provides a positive detent stop for the tip 130 of the actuator lever 112. The bearing surface 128 is positioned and angled so that the tip 130 of the actuator lever 112 rides along the surface 128 and moves or rotates the brake lever 104 when an operator presses one side or the other of the button 106 depending on whether the brake is being locked or released.

FIG. 4 shows the brake assembly 100 in the released position. In this example, each wheel 92 is provided with a plurality of radially extending and axially projecting spokes 132 around a circumference of a hub 134 of the wheel. If a user wishes to apply the brake on a given foot assembly 40, the user depresses a front end 140 of the button 106 (further from the hosel), causing the brake actuator 102 to pivot toward the user about the actuator pivot 114. This raises the actuator lever 112, releasing its distal end 130 from the detent region 126. A spring 142 rotationally biases the brake lever 104 to the locked position as shown in FIG. 5 about the brake pivot 116. In this position, the finger 120 rotates toward and drops into a gap between a pair of the spokes 132 on the wheel 92 to prevent wheel rotation.

If a user wishes to release the brake assembly 100 on a given foot assembly 40, the user pushes the rear end 144 of the button 106 which rotates the actuator 102 about the actuator pivot 114 away from the user and lowers the actuator lever 112. The distal end 130 of the actuator lever bears against the bearing surface 128, which in turn moves the brake lever 104 against the biasing force of the spring 142. As the brake actuator 102 rotates about the actuator pivot 114 with the actuator lever 112 moving downward, the brake lever 104 rotates away from the wheel to release the finger 120 from within the spokes. When the distal end 130 of the actuator lever 112 reaches the detent region 126, the end snaps into the region and locks the brake assembly 100 in the release position. The wheel can freely rotate in the released position of the brake assembly 100 as shown in FIG. 4.

As will be evident to those having ordinary skill in the art, the various features, components, and function of the brake assembly 100 can also vary considerably and yet fall within the spirit and scope of the present invention. If no wheel is provided on the foot assemblies 40, then no brake assembly 100 would be required. In an alternative example, the actuator and brake lever components can be part of one single component manipulated by a user to directly inhibit or permit rotation of the wheel. However, in the disclosed example, these two components are separate devices that interact with one another.

According to the disclosed example of the present invention, the contour of surfaces on part of each foot body 82 provides improved stability for the folded high chair when the folded chair is an upright position resting on its feet. Each ankle or hosel 84 is positioned at the heel end of the foot body. The hosel 84 in this example has an axis H that is positioned co-linear with an axis L of the leg 22 or 24 to which it is attached. The axis H is oriented at an angle β relative to a plane of the bottom surface 88 of the foot body 82 in this example. Each foot body 82 has a length extending in a direction away from the hosel 84 and the axis H of the hosel. The toe surface 90 is positioned at an end of the bottom surface 88 opposite the hosel 84. Thus, the location of the toe surface 90 is offset a distance from the axis H of the hosel and the axis L of the respective leg 22 or 24.

The toe surface 90 in this example is at an angle (90°−β) relative to the plane of the bottom surface 88. The angle in this example is such that the hosel axis H and a plane of the toe surface are at 90° relative to one another. This is because of the geometry of the legs 22 and 24 when folded. In this example, the legs are vertical and parallel to one another in the folded configuration. The toe surfaces 90 in this example are each intended to be parallel with one another and with the ground or floor on which the folded high chair will rest. Also, each foot assembly 40 is oriented on its respective leg 22 or 24 in this example so that the toe surface is offset in a direction further forward if on a front leg and further rearward if on a rear leg.

As can be seen in FIG. 2, when the A-frame assembly 12 is in the in-use configuration, each pair of front and rear legs 22 and 24 is orientated at an angle of (2×β) relative to one another. When in this position, the bottom surface 88 of each foot assembly 40 in this example is essentially parallel to the ground or floor on which the high chair rests. The toe surface 90 of each foot assembly 40 is positioned at an end opposite the heel end of its respective foot. The toe surface 90 of each foot assembly 40 angles upward away from the ground. When the A-frame assembly 12 is moved to the folded configuration as shown in FIG. 3, each pair of front and rear legs 22 and 24 pivots through an angle β to a vertical position, until parallel and closely spaced relative to the adjacent rear or front legs.

In this example, the heel ends of the foot bodies 82 on the adjacent front and rear legs of frame assembly 12 abut one another in the folded configuration. The lower ends 30 and 32 of the adjacent legs 22 and 24 are quite close to one another. Also, each toe surface 90 becomes oriented essentially parallel to the ground surface. However, the toe surface 90 on each front foot assembly 40 is offset forward a distance D from the axis L of the front leg lower ends 30. Similarly, the toe surface 90 of each rear foot assembly 40 is offset rearward a distance D from the axis L of the rear leg lower ends 32. Thus, the distance is (2×D) from the front toe surfaces to the rear toe surfaces. This creates a more stable base on which the high chair can rest when in the folded configuration than if the high chair rested on the bottoms of the front and rear legs. The deeper footing base between the front and rear frame sections 20 and 21 permits the folded high chair to stand up and remain standing up in a relatively stable configuration while the majority of the high chair is folded to a substantially thin profile.

In the disclosed example, each front foot extends essentially directly forward and each rear foot extends essentially directly rearward and thus in opposite directions. In an alternative example, the feet can extend both forward and rearward and can be rotated a desired amount outward from the side of the high chair to also increase the side-to-side base width between the floor contact points of the folded high chair. This can further increase the stability of the high chair when it is standing in an upright, folded configuration.

There are numerous ways in which the stable base characteristics of the present invention can be described. Simply put, the front frame section 20 can be described as having a front plane extending between the front legs and the rear frame section 21 as having a rear plane extending between the rear legs. When the high chair is compactly folded, the front and rear planes lie close to one another, and parallel to one another in the disclosed example. One example has been described herein in which the frame contact points at the lower end of the folded frame assembly can be moved from lying within the front and rear planes to positions further forward, further rearward, and/or further laterally outward relative to the front and rear planes. By doing so, the tipping moment or moment of inertia can be altered or reduced to help the upright folded high chair resist tipping over.

The bottom surfaces 88 of the foot assemblies need not be planar or flat in any instance, and especially if the wheels 92 are employed. The toe surfaces 90 also need not be planar flat. Simply by moving the base contact points of the folded frame assembly away from one another increases the stability of the upright standing high chair when folded. However, use of flat or planar to surfaces 90 with some degree of surface area may assist in further improving stability for the folded upright high chair.

Although certain high chair examples have been described herein in accordance with the teachings of the present disclosure, the scope of coverage of this patent is not limited thereto. On the contrary, this patent covers all embodiments of the teachings of the disclosure that fairly full within the scope of permissible equivalents.

What is claimed is:

1. A high chair frame assembly comprising:
a front section with an upper end, a lower end, and a side-to-side front reference plane;
a rear section with an upper end, a lower end, and a side-to-side rear reference plane, the upper ends of the front and rear sections pivotally coupled to each other and the front and rear sections reconfigurable between an in-use configuration with the lower ends spaced apart from one another and a folded configuration with the lower ends closely spaced a compact distance from one another;
a front foot assembly carried on the lower end of the front section and having a front contact surface positioned for use when in the folded configuration; and
a rear foot assembly carried on the lower end of the rear section and having a rear contact surface positioned for use when in the folded configuration, wherein a foot distance between the front and rear contact surfaces is greater than the compact distance between the front and rear lower ends.

2. A high chair frame assembly according to claim 1, wherein the front and rear planes are substantially parallel to one another in the folded configuration.

3. A high chair frame assembly according to claim 1, wherein the front frame section has a pair of front legs spaced laterally apart from one another, and wherein the rear frame section has a pair of rear legs spaced laterally apart from one another.

4. A high chair frame assembly according to claim 3, wherein each of the front and rear legs has a linear configuration, the side-to-side front and rear reference planes being defined between the respective front and rear legs.

5. A high chair frame assembly according to claim 1, further comprising:
a pair of front legs on the front section and each having a front leg axis;
a front foot assembly carried on the lower end of each front leg;
a pair of rear legs on the rear section and each having a rear leg axis; and
a rear foot assembly carried on the lower end of each rear leg.

6. A high chair frame assembly according to claim 5, wherein the front contact surface of each front foot assembly is offset forward a distance from the respective front leg axis, and wherein the rear contact surface of each rear foot assembly is offset rearward a distance from the respective rear leg axis.

7. A high chair frame assembly according to claim 5, wherein each front and rear foot assembly has a bottom surface, a portion of which contacts a support surface when in the in-use configuration.

8. A high chair frame assembly according to claim 7, wherein each front and rear foot assembly includes a wheel protruding from the respective bottom surface that contacts the support surface in the in-use configuration.

9. A high chair frame assembly according to claim 8, wherein each front and rear foot assembly includes a wheel brake assembly.

10. A high chair with a foldable frame assembly comprising:
a front frame section with two front legs laterally spaced apart from one another, each front leg having an upper end, a lower end, and a front leg axis;
a rear frame section with two rear legs laterally spaced apart from one another, each rear leg having an upper end, a lower end, and a rear leg axis;
hubs pivotally connecting the upper ends of one of the front legs and one of the rear legs to one another on each side of the frame assembly, the frame assembly being reconfigurable between an in-use configuration with the front and rear frame sections angularly spaced apart relative to one another and a folded configuration with the front and rear frame sections closely spaced a compact distance from one another;
two front foot assemblies carried one each on the lower end of each of the front legs and each having a front in-use resting surface and a front folded resting surface; and
two rear foot assemblies carried one each on the lower end of each of the rear legs and each having a rear in-use resting surface and a rear folded resting surface, wherein the front and rear folded resting surfaces lie in substantially the same plane with one another in the folded configuration, and wherein a foot distance between the front and rear folded resting surfaces on each side of the frame assembly is greater than the compact distance between the lower ends of the front and rear frame sections.

11. A high chair according to claim 10, wherein the front and rear foot assemblies are each separate components connected to their respective front and rear legs.

12. A high chair according to claim 10, wherein each of the front and rear folded resting surfaces is a substantially flat surface oriented at a right angle relative to the respective front or rear leg axis.

13. A high chair according to claim 10, wherein the front and rear legs are linear components.

14. A high chair according to claim 13, wherein the front and rear legs lie substantially parallel to one another when in the folded configuration.

15. A high chair according to claim 10, wherein each of the front and rear foot assemblies has a wheel defining the respective front or rear in-use resting surface.

16. A high chair according to claim 15, wherein each of the front and rear foot assemblies includes a wheel brake assembly.

17. A high chair comprising:
a foldable frame assembly with a front frame section and a rear frame section pivotally coupled to one another at respective upper ends, the frame assembly movable to a folded configuration with the front and rear frame sections spaced a close distance relative to one another; and
a front and a rear toe surface on the respective lower ends of the front and rear frame sections, the front and rear toe surfaces spaced a stabilizing distance from one another in the folded configuration, the stabilizing distance being greater than the close distance.

18. A high chair according to claim 17, wherein the front toe surface is carried on a front foot assembly attached to the lower end of the front frame section, and wherein the rear toe surface is carried on a rear foot assembly attached to the lower end of the rear frame section.

19. A high chair according to claim 17, wherein the front frame section has a plurality of linear front legs and wherein the rear frame section has a plurality of linear rear legs.

20. A high chair according to claim 17, wherein the front and rear frame sections lie substantially parallel to one another in the folded configuration.
